(19) United States
(12) Patent Application Publication
(10) Pub. No.: US 2023/0192076 A1
(43) Pub. Date: Jun. 22, 2023

(54) SYSTEM AND METHOD OF CLUSTERING OF ISOLATED OBJECTS TO BETTER REPRESENT REALITY

(71) Applicant: Ignacio Martin-Bragado, Mountain View, CA (US)

(72) Inventor: Ignacio Martin-Bragado, Mountain View, CA (US)

(21) Appl. No.: 17/559,408

(22) Filed: Dec. 22, 2021

(51) Int. Cl. B60W 30/095; B60W 30/09; B60W 60/00

(52) U.S. Cl. CPC B60W 30/095; B60W 30/09; B60W 60/0015; B60W 2554/4049

(57) ABSTRACT

Disclosed herein are systems and methods including a method for improving how real assets are presented in simulations of street scenes. The method includes generating a simulation of a physical scene, the simulation having a first object with a first label and a second object with a second label, determining, via a model that applies a reaction map and a reaction distance, whether the first object and the second object should be clustered together such that the first label and the second label are replaced with a third label and outputting, from the model and based on the reaction map and the reaction distance being applicable to the first object and the second object, the third label for the first object and the second object.

### FIELD OF THE DISCLOSURE

The present disclosure relates to autonomous vehicles (AVs) and furthermore to an approach to processing independent objects to identify clusters of objects that have some type of interaction to better represent reality in a simulation.

### INTRODUCTION

Autonomous vehicles (AVs) at least to some degree are starting to appear in our economy. In some cases, an AV includes sensors that enable it to determine whether other vehicles or objects are in its way or in the vicinity of the AV. Cars, people, bicycles, animals and so forth can be seen or viewed by a sensor and are called objects or assets. The system may put a “box” around an object or an item as it seeks to determine what it is, how it is moving and so forth. In some cases, companies may use simulations of street scenes to help to operate or train the AV to go to the right route and avoid collisions.

A challenge exists where in some cases the system may classify objects as people, animals, cars, and so forth but they will simply treat or process and label each object separately. Thus, the simulation might be produced showing the various objects which in the simulation data in which each object is merely defined and displayed as a separate object.

### BRIEF DESCRIPTION OF THE FIGURES

Illustrative embodiments of the present application are described in detail below with reference to the following figures:

FIG. 1 illustrates an example of a system for managing one or more Autonomous Vehicles (AVs) in accordance with some aspects of the present technology;

FIG. 2 illustrates an example environment in which objects can be detected and classified by a system to generate a synthetic environment;

FIG. 3A illustrates how objects can be determined to be clustered together and thus have their labels combined into a single label;

FIG. 3B illustrates an example of a person and an animal having their labels clustered together into a single label;

FIG. 4 illustrates an example method; and

FIG. 5 illustrates a computing device which can be used in the various examples disclosed herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

### BRIEF INTRODUCTION OF THE DISCLOSURE

This disclosure relates to the simulation of physical scenes such as a scene associated with a car driving down a road. People, other cars, trees, bikes, animals and so forth are likely to be seen by the driver. A simulation of such a scene can be performed using models to model the various objects in the scene. Real data from on-road cameras as well might be used to generate a simulation of the scene. Typically, the system will put a “box” around each object that then gets assigned a label, for example, as a car, a person, an animal, a bike and so forth. The disclosure focuses on how to determine whether two or more objects that have been separately labeled should be combined or clustered together to have a single common label which describes both the objects and how they interact. The updated new label can then be used in the simulation such that the objects can be presented in a more realistic and accurate way than might otherwise occur in the simulation when they are processed as separate and independent objects.

For example, to translate the labels associated with objects from the road into an application for the simulation input, typically the process proceeds to process each object one by one, assuming that the respective labels do not provide any cross-context between potentially related objects. This disclosure removes that assumption by having a preliminary pass on all the labels to seek to understand the context of the labels by providing a “reaction map” and a “reaction distance” that agglomerates the labels (where appropriate) into “clusters”. For instance, two isolated objects like “bike” and “static object” can get clustered together to be interpreted as “bike locked to a rack, or bike leaning on a rack”, thus generating a new label. The new label encompasses one, two or more objects and can cause the simulation system to adjust how the object(s) are presented.

In one example, the interaction or relationship between two or more objects can be called “reactions”. The isolated entities in a scene can be agglomerated into clusters if they are close enough (as defined by a reaction distance parameter) to each other. An example of a reaction can be a person who is walking a dog. There is a relationship between the person object and the dog object that might cause or impact how they move relative to each other, how they are posed, whether there is another object (leash) that connects the two objects and so forth. A “reaction” can also describe how, when the object(s) have the interactive relationship, a new label is assigned rather than two separate labels for the respective objects. Example reactions are “person + animal -> personal walking animal”, “person + bike -> person walking bike”, “bike + bike + ... + bike -> bike station”, or “barrier + barrier -> longest barrier”. These reactions can be characterized as how the system might take two independent labels associated with respective objects and determine how they might react together and generate a new appropriate label for the combination of two or more objects.

The disclosed approach will improve the realism of the generated scene by extracting context from the local relations between labels. The “blocks” to be shown in the simulation will not be isolated labels anymore. “Clusters” might contain just one, but sometimes two or more labels, and the presence of clusters will change the meaning of the label. For instance, in the “person + animal” set of objects/labels, the system will have a person and a detached animal, but once they “react” and are seen as a “cluster”, the final objects or assets will be considered a person walking a dog (i.e., they will have an attachment that might also include a leash).

An example method can provide a way for objects with separate labels to be clustered into a single label. The method can include generating a simulation of a physical scene, the simulation having a first object with a first label and a second object with a second label, determining, via a model that applies a reaction map and a reaction distance, whether the first object and the second object should be clustered together such that the first label and the second label are replaced with a third label and outputting, from the model and based on the reaction map and the reaction distance being applicable to the first object and the second object, the third label for the first object and the second object.

In one aspect, the method can further include outputting an updated simulation including the first object and the second object being presented in the updated simulation according to the third label. Outputting the updated simulation further can include changing the simulation to add at least one feature to the updated simulation. In one aspect, the first object is static and the second object may not be not static. The first object and the second object may both not be static or both be static.

A system example can include a processor and a computer-readable storage device storing instructions which, when executed by the processor, cause the processor to perform operations including generating a simulation of a physical scene, the simulation having an asset, generating a simulation of a physical scene, the simulation having a first object with a first label and a second object with a second label, determining, via a model that applies a reaction map and a reaction distance, whether the first object and the second object should be clustered together such that the first label and the second label are replaced with a third label and outputting, from the model and based on the reaction map and the reaction distance being applicable to the first object and the second object, the third label for the first object and the second object.

### DETAILED DESCRIPTION OF THE DISCLOSURE

The present disclosure addresses the problem with respect to how accurate and real are simulated objects or assets within a scene that can be used in some aspect to enable an autonomous vehicle (AV) to properly and safely travel along a road. This disclosure primarily focuses on a technique for clustering together two or more objects (each having their own labels) that “react” together or have some type of connection such that a new label can be generated that defines the group of objects and wherein a simulation can be updated or generated which presents the group of objects (such as a person walking a dog) in a more realistic way with respect to a pose of the object, a movement of the object, an additional feature like a leash, a bike rack, a lock on a bike, and so forth. By clustering objects together that appropriately have a relationship, the simulation system can improve how the objects are presented and make it more realistic for a viewer or for other purposes such as training systems for AVs.

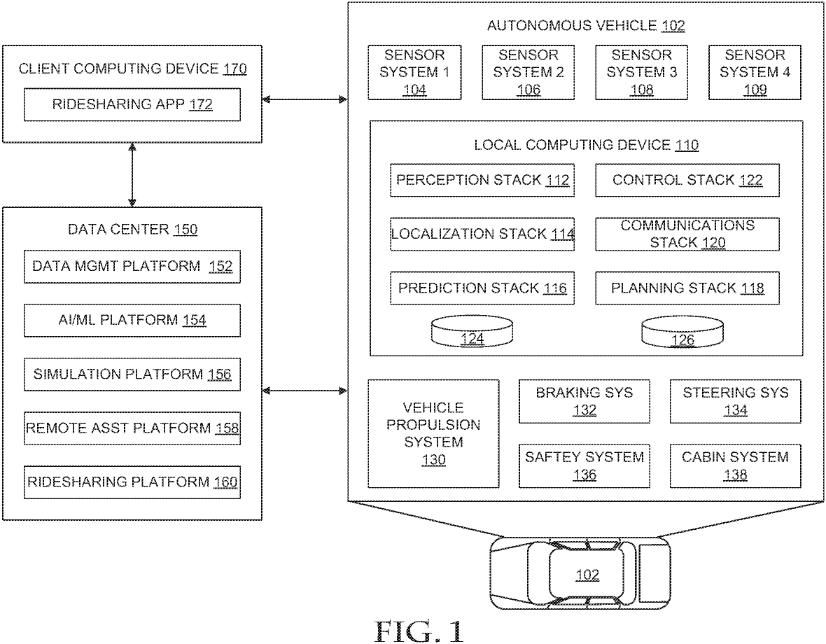

Inasmuch as data which can be used to simulate a scene can be used to operate autonomous vehicles, FIG. 1 is presented first which discusses in general various aspects of AVs. The AV in FIG. 1 might be used to generate on-road data for use in training the models or making clustering decisions as disclosed herein or it might have other machine learning or other models that utilize improved simulation data as is describe herein.

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an autonomous vehicle (AV) 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, 108 and 109. The sensor systems 104-109 can include different types of sensors and can be arranged about the AV 102. For instance, the sensor systems 104-109 can include Inertial Measurement Units (IMUs), cameras (e.g., still image cameras, video cameras, etc.), light sensors (e.g., LIDAR (Light Detection and Ranging) systems, ambient light sensors, infrared sensors, etc.), RADAR systems, GPS (Global Position System) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Sensor system 109 can be a different type of sensor such as a camera. Other embodiments may include any other number and type of sensors. The sensors can be used in one aspect to generate real on-road data that is used to train a machine learning models or to make clustering decisions as disclosed herein.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-109, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-109; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-109, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.). Note that the clustering concept disclosed herein might be implemented via the perception stack 112 or via any other component or combination of components.

The mapping and localization stack 114 can determine the AV’s position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-109 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Note that the prediction stack 116 might be adjusted with respect to its output given the clustering of labels disclosed herein. For example, the prediction of a future path for one or more objects might change for a person and an animal if they are clustered together to be labeled as a person walking a dog. There might be a first prediction for the person and animal without clustering but a second and different (or the same perhaps) prediction for the combination of the person and animal. Thus, the clustering of labels as described herein can impact other stacks in the AV 102.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes. As noted above, the clustering concept might impact the planning stack 118 in that a first plan might change to a second plan if objects are clustered together. The updated label(s) can be provided to the planning stack 118 and it can be trained to adjust its planning based on clustered labels.

The control stack 122 can manage the operation of the vehicle propulsion system 130, the braking system 132, the steering system 134, the safety system 136, and the cabin system 138. The control stack 122 can receive sensor signals from the sensor systems 104-109 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can include multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-109, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-109, roadside assistance requests, software updates, ridesharing pick-up and drop-off instructions, and so forth. In this example, the data center 150 includes a data management platform 152, an Artificial Intelligence/Machine Learning (AI/MI,) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on. Note that the AI/ML platform 154 can be the same or different from the machine learning models described below to evaluate assets in simulations for how real they look.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on. As the present disclosure relates to how to improve simulations using the machine learning model disclosed herein, the principles can be included in or improve the simulation platform 156 disclosed in FIG. 1. The clustering concept of course can impact the simulation platform 156 by changing how the simulation might present objects when they are clustered relative to separate and independent objects as they might originally be modeled or planned to be presented.

The remote assistance platform 158 can generate and transmit instructions regarding the operation of the AV 102. For example, in response to an output of the AI/MI, platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

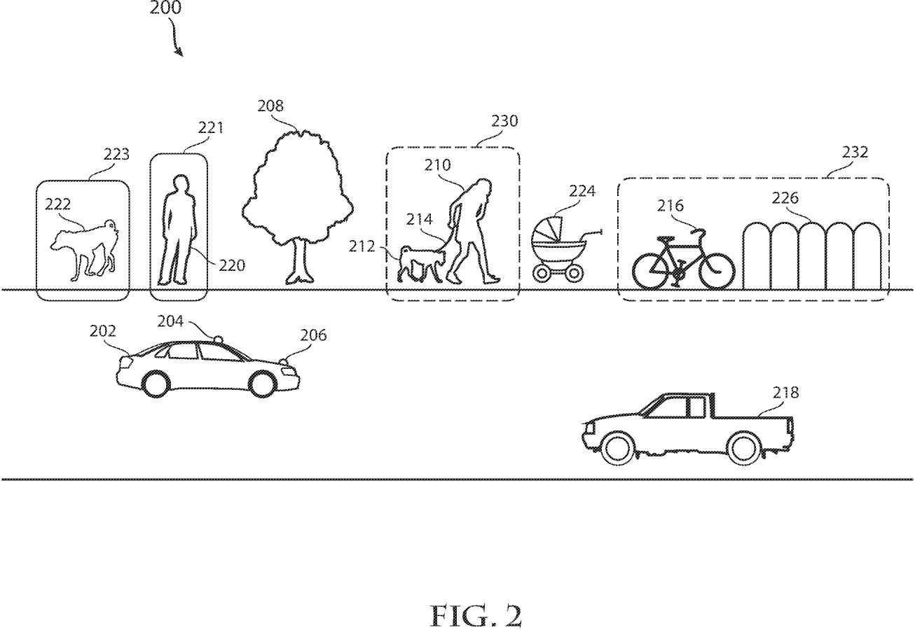

This disclosure now turns to the details which are the focus of this application and which involve using a reaction map and a reaction distance to determine whether one or more labeled objects should be clustered such that they share a common label. Using the principles disclosed herein, a system can agglomerate into clusters entities that were previously processed in an isolated way. The agglomeration occurs only when two or more respective entities are close enough to each other as defined by a reaction distance parameter so as to justify clustering them together. FIG. 2 illustrates an example simulation 200 of a scene which can include various assets or objects such as a car 206, another vehicle 218, an animal 222, a person 220, a tree 208, a second person 210, a dog 212 having a leash 214, a stroller 224, a bicycle 216 and a bike rack 226. Each asset may be generated from a computer model that has data such as size, shape, color, and so forth that can be translated into visual data that can be seen in a simulation. The vehicle 202 can also represent a real vehicle that can have a first sensor like a camera 202 and a second sensor like a LIDAR 204. Some of the data used for simulation might come from such sensors or may be purely generated data by a computer system via various models. The question as introduced above is whether any one or more of the shown objects should be clustered together such that in a simulation they are presented differently than they otherwise would if they were simply identified and represented independent of each other.

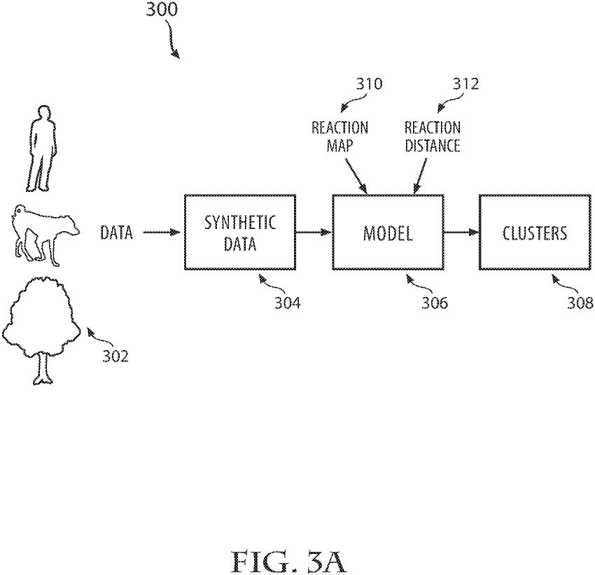

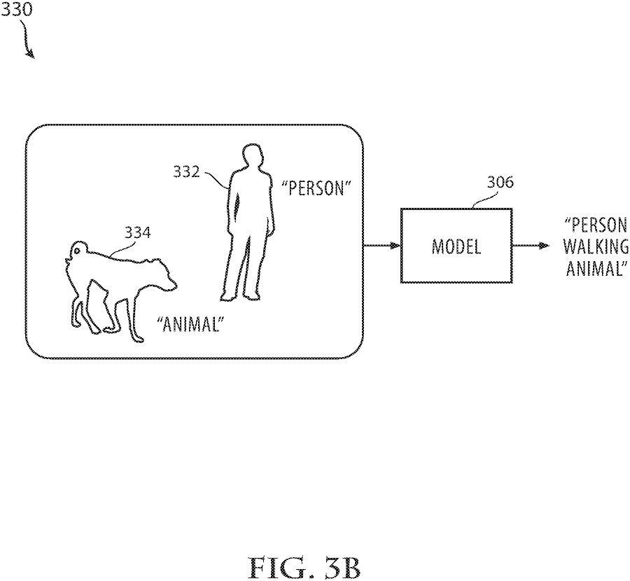

FIG. 3A illustrates some of the basic operations 300 of this disclosure. Data 302 such as data about trees, cars and people is provided to a simulator to generate a simulation 304. The data 302 can represent various models of the different assets. The system can for example select a certain model for a tree, and a certain model for an animal, a person or a car. The simulation can be of a street scene in which assets (the various objects in a scene) move or are presented in the simulation. The simulations can be used by companies that build autonomous vehicles such as is shown in FIG. 1. The issue is therefore how good the simulation is relative to real life and how an asset might look to a human viewer. How close to real life are the assets presented. The asset may vary with respect to its color, the light reflection, the orientation, the movement, and so forth. It can be very expensive for a person to actually view the simulation and make manual judgements on how real each asset looks. This disclosure addresses this issue by introducing a model 306 r other application that can evaluate the synthetic data 304 and identify and apply a reaction map 310 and a reaction distance 312 to the various objects 302 that are the scene and make determinations regarding whether one or more objects should be clustered in that what previous was two separate labeled objects (such as a person and an animal) are combined into a single labeled object such as a person walking a dog. The model 306 will output the clusters 308 and can be a pass across the data after the synthetic data 304 is processed to identify the objects 302 and get them labeled.

The reaction map 310 can be a table or database associated with now two or more labels might be mapped into one label based on the reactions. Examples are discussed above of how the reaction map might cause a person label and an animal label to be mapped to a single person walking a dog label. The reaction distance can relate to a physical distance between the objects. If a person and a dog are in the scene but on opposite sides of a road or say 30 feet apart, then a reaction distance might be too large to cluster those two objects/labels according to the reaction map.

The reaction distance 312 might be variable and based on a particular entry in the reaction map. For example, a distance between a bike and a bike rack which causes the two labels to be clustered might be different than the distance between a person and a dog. Some dog leashes might be 15 feet long and thus the reaction distance might take that into account. Thus, the reaction distance can depend on the particular reaction being considered. A bike that is 15 feet from a bike rack might not be close enough to be considered a reaction between the two objects. Thus, the structure of the data might be that there is a dynamic reaction distance that is applied to each set of objects in the reaction map.

The model 306 can include a machine learning model that can be trained to evaluate the simulation and determine outputs based on the reaction map 310 and the reaction distance 312. The reaction distance 312 can include a physical distance between the first object and the second object 302. The reference to “reactions” can relate to how any two objects might interact or be related. The reactions can be based on any number of factors such as a pose of a human and whether they are leaning forward, turning, looking up or down, or have their arms in a certain position which can indicate that they are holding a leash or pushing a stroller. The reactions can be based on the tilt of a bicycle or the turn of a bicycle wheel individually or relative to other bicycle wheels. The reactions can be included in a map that is provided to the model 306 which can cause the model to consider whether a person 210 and an animal 214 should be clustered together as a “person walking animal”.

FIG. 3B illustrates a simulated image 330 which has a bike 332 and a car 334. These can be generated via the use of models generated from the data 302 used as the basis for the simulation. The models can be then translated into synthetic data for the simulation 330 of assets in a scene.

The model 306 can first determine whether classified assets are present. In this case, the machine learning model 306 might identify a person 332 and an animal 334. The model 306 can apply the reaction map 310 and the reaction distance 312 to the objects 332, 334 and output a new combined label of “person walking animal” or “person walking dog”.

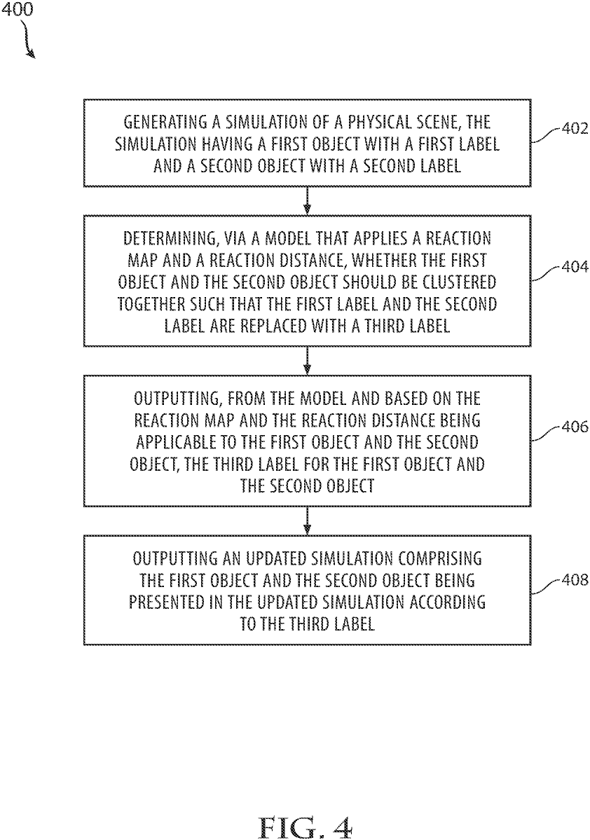

FIG. 4 illustrates and example method 400. The method 400 can include one or more of the following steps in any order. The method can include generating a simulation of a physical scene, the simulation having a first object with a first label and a second object with a second label (402), determining, via a model that applies a reaction map and a reaction distance, whether the first object and the second object should be clustered together such that the first label and the second label are replaced with a third label (404) and outputting, from the model and based on the reaction map and the reaction distance being applicable to the first object and the second object, the third label for the first object and the second object (406).

The simulation system will utilize the new label and change how the previously independent objects will be simulated. The new simulation might change one or more of a pose, a manner of movement like walking, a route the object(s), a speed of the object(s), a rotational or other value associated with the movement of the object(s), a coordination of movement between two or more objects, a determination about whether a respective object is static or dynamic, a distance between objects, a color or shading associated with the object(s).

The model 306 can output the third label for more than two objects that are found to be related and thus should be clustered together and characterized by the third label.

In one example, the pass over the data via the use of the model 306 might cause a single label, such as for a person, to be changed to another label and thus “clustered” in a sense even though there is not another object or label attached to it. The label of a person on the side of the road for example might be changed to “person running” which can give it more context and which can affect the movement, speed and motion. The change might be due to other objects in the scene such as other people running, an animal running at the person but that is too far away to be connected via a leash, and other reasons. The idea is that based on the analysis of the scene and the various objects in the scene, a label can be updated or changed which can cause resulting changes to the simulation to make it more real.

In one aspect, the method can further include outputting an updated simulation including the first object and the second object being presented in the updated simulation according to the third label (408). Outputting the updated simulation further can include changing the simulation to add or change at least one feature to the updated simulation. Changes can include adding objects (such as a bike, a leash, a stroller), changing how an object is presented in any number of different ways (such as its orientation, how it moves, or adding to an object such as expending a bike rack), and so forth.

In one aspect, the first object is static and the second object may not be not static. The first object and the second object may both not be static or both may be static.

The new simulation might also add new physical objects to the scene such as a leash, an umbrella, a new or extended portion of a bike rack, a lock, a bench, a new bike, and so forth. For example, a bike and a bike rack might “react” and be combined with a label of a bike attached to a bike rack. The system may adjust the bike rack to expand the rack for example and add another locked-up bike to make it look more realistic.

The step of determining, via the model that applies the reaction map and the reaction distance, whether the first object and the second object should be clustered together further can include extracting a context from local relations between the first label and the second label.

In another aspect, the method can include using the third label to adjust the simulation such that a physical connection is shown in some manner between the first object and the second object as a coordinated set of objects defined by the third label.

A system example can include a processor and a computer-readable storage device storing instructions which, when executed by the processor, cause the processor to perform operations including generating a simulation of a physical scene, the simulation having an asset, generating a simulation of a physical scene, the simulation having a first object with a first label and a second object with a second label, determining, via a model 306 that applies a reaction map 310 and a reaction distance 312, whether the first object and the second object should be clustered together such that the first label and the second label are replaced with a third label and outputting, from the model 306 and based on the reaction map 310 and the reaction distance 312 being applicable to the first object and the second object, the third label for the first object and the second obj ect.

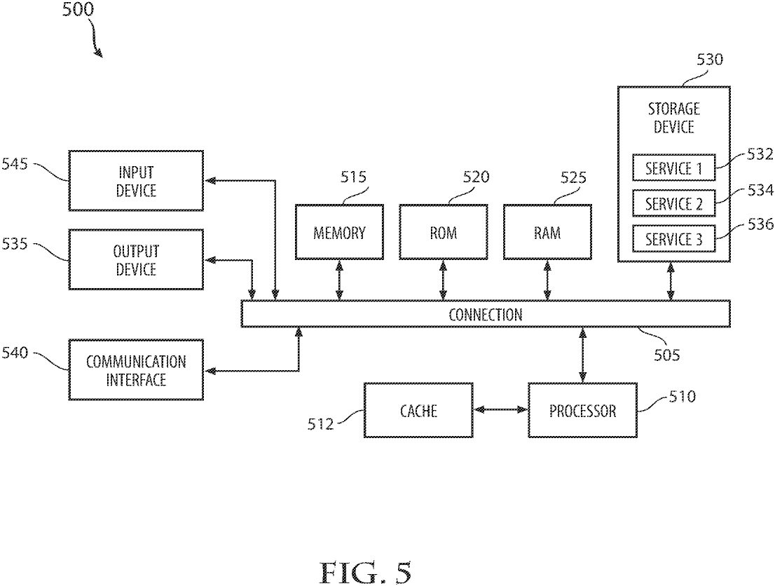

FIG. 5 illustrates an architecture of an example computing device 500 which can implement the various techniques described herein. For example, the computing device 500 can implement the autolabeler module 502 shown in FIG. 5. The components of the computing device 500 are shown in electrical communication with each other using a connection 505, such as a bus. The example computing device 500 includes a processing unit (CPU or processor) 510 and a computing device connection 505 that couples various computing device components including the computing device memory 515, such as read-only memory (ROM) 520 and random access memory (RAM) 525, to the processor 510. The computing device 500 can include a cache of high-speed memory connected directly with, in close proximity to, or integrated as part of the processor 510. The computing device 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions.

Other computing device memory 515 may be available for use as well. The memory 515 can include multiple different types of memory with different performance characteristics. The processor 510 can include any general purpose processor and hardware or software service, such as service 1 532, service 2 534, and service 3 536 stored in storage device 530, configured to control the processor 510 as well as a special-purpose processor where software instructions are incorporated into the processor design. The processor 510 may be a self-contained system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art, such as a display, projector, television, speaker device, etc. In some instances, multimodal computing devices can enable a user to provide multiple types of input to communicate with the computing device 500. The communications interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include services 532, 534, 536 for controlling the processor 510. Other hardware or software modules are contemplated. The storage device 530 can be connected to the computing device connection 505. In one aspect, a hardware module that performs a particular function can include the software component stored in a computer-readable medium in connection with the necessary hardware components, such as the processor 510, connection 505, output device 535, and so forth, to carry out the function.

For clarity of explanation, in some instances, the present technology may be presented as including individual functional blocks including functional blocks including devices, device components, steps or routines in a method embodied in software, or combinations of hardware and software.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods, according to the above-described examples, can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components, computing devices and methods within the scope of the appended claims.

Claim language reciting “at least one of” a set indicates that one member of the set or multiple members of the set satisfy the claim. For example, claim language reciting “at least one of A and B” means A, B, or A and B.

We claim:

1. A method comprising:
generating a simulation of a physical scene, the simulation having a first object with a first label and a second object with a second label;
determining, via a model that applies a reaction map and a reaction distance, whether the first object and the second object should be clustered together such that the first label and the second label are replaced with a third label; and
outputting, from the model and based on the reaction map and the reaction distance being applicable to the first object and the second object, the third label for the first object and the second object.

2. The method of claim 1, wherein the model comprises a machine learning model and is trained to evaluate the simulation and determine outputs based on the reaction map and the reaction distance.

3. The method of claim 1, wherein the reaction distance comprises a physical distance between the first object and the second object.

4. The method of claim 1, wherein the model outputs the third label for more than two objects that are found to be related and thus should be clustered together and characterized by the third label.

5. The method of claim 1, further comprising:
outputting an updated simulation comprising the first object and the second object being presented in the updated simulation according to the third label.

6. The method of claim 5, wherein outputting the updated simulation further comprises changing the simulation to add at least one feature to the updated simulation.

7. The method of claim 1, wherein the first object is static and the second object is not static.

8. The method of claim 7, wherein the first object and the second object are both not static or both are static.

9. The method of claim 1, wherein the determining, via the model that applies the reaction map and the reaction distance, whether the first object and the second object should be clustered together further comprises extracting a context from local relations between the first label and the second label.

10. The method of claim 1, further comprising:
using the third label to adjust the simulation such that a physical connection is shown in some manner between the first object and the second object as a coordinated set of objects defined by the third label.

11. A system comprising:
a processor; and
a computer-readable storage device storing instructions which, when executed by the processor, cause the processor to perform operations comprising:
generating a simulation of a physical scene, the simulation having an asset;
generating a simulation of a physical scene, the simulation having a first object with a first label and a second object with a second label;
determining, via a model that applies a reaction map and a reaction distance, whether the first object and the second object should be clustered together such that the first label and the second label are replaced with a third label; and
outputting, from the model and based on the reaction map and the reaction distance being applicable to the first object and the second object, the third label for the first object and the second object.

12. The system of claim 11, wherein the model comprises a machine learning model and is trained to evaluate the simulation and determine outputs based on the reaction map and the reaction distance.

13. The system of claim 11, wherein the reaction distance comprises a physical distance between the first object and the second object.

14. The system of claim 11, wherein the model outputs the third label for more than two objects that are found to be related and thus should be clustered together and characterized by the third label.

15. The system of claim 11, further comprising:
outputting an updated simulation comprising the first object and the second object being presented in the updated simulation according to the third label.

16. The system of claim 15, wherein outputting the updated simulation further comprises changing the simulation to add at least one feature to the updated simulation.

17. The system of claim 11, wherein the first object is static and the second object is not static.

18. The system of claim 17, wherein the first object and the second object are both not static or both are static.

19. The system of claim 11, wherein the determining, via the model that applies the reaction map and the reaction distance, whether the first object and the second object should be clustered together further comprises extracting a context from local relations between the first label and the second label.

20. The system of claim 11, further comprising:
using the third label to adjust the simulation such that a physical connection is shown in some manner between the first object and the second object as a coordinated set of objects defined by the third label.
